(19) United States
(12) Patent Application Publication
(10) Pub. No.: US 2016/0112833 A1
(43) Pub. Date: Apr. 21, 2016

(54) LOCATION-BASED CONTROL OF MOBILE DEVICE RING MODE

(71) Applicant: SEPTIER COMMUNICATION LTD., Petach-Tikva (IL)

(72) Inventors: Yaron BARATZ, Herzliya (IL); Gosta TIXELL, Caesarea (IL)

(21) Appl. No.: 14/883,802

(22) Filed: Oct. 15, 2015

Related U.S. Application Data
(60) Provisional application No. 62/064,392, filed on Oct. 15, 2014.

(51) Int. Cl. H04W 4/02; H04W 88/02

(52) U.S. Cl. CPC H04W 4/02; H04W 88/02

(57) ABSTRACT

A system for location-based control of a ring mode of mobile communication devices includes a server configured to communicate with the devices via a network. The server is also configured to receive from a device an indication to change a zone designation of a geographic region at a current location of the device to a silent zone. Any previously received indications for the change of zone designation from other devices are retrieved. If a criterion for implementing the indicated change is met, a change of the zone designation to a silent zone is recorded. The ring mode of a mobile communication device that is located within that geographic region is automatically switched to silent mode.

### CROSS REFERENCE TO RELATED APPLICATIONS

The present invention claims the benefit of U.S. Provisional Patent Application No. 62/064,392 filed on Oct. 15, 2014, which is incorporated in its entirety herein by reference.

### FIELD OF THE INVENTION

The present invention relates to mobile devices such as cellular telephones. More particularly, the present invention relates to location-based control of a ring mode of a mobile device.

### BACKGROUND OF THE INVENTION

Cellular telephones (cell phones) and similar mobile communication devices present a source of annoyance and human noise pollution. Cell phones produce audible sounds (sound notifications or ringtones) when receiving incoming communications. Such produced sounds may, under certain circumstances, be disruptive to the surroundings and may prove embarrassing to the cell phone user. For example, produced sounds may prove disruptive during performances, concerts, speeches, classes, lectures, meetings, funerals, prayer services, or other human activities.

Cell phone handsets are designed with a silent or vibrate mode in which audible sounds are turned off. Manually switching to silent mode is a simple operation. However, many cell phone users forget to carry out this simple operation in a timely manner, sometimes resulting in disruption or embarrassment. Similarly, a cell phone user who switched the cell phone to the silent mode may forget to switch back to ringtone mode when silent mode is no longer necessary, thus risking missing incoming communications.

### SUMMARY OF THE INVENTION

There is thus provided, in accordance with an embodiment of the present invention, a system for location-based control of a ring mode of each device of a plurality of mobile communication devices, the system including: a server configured to communicate with the plurality of mobile communication devices via a network and configured to: receive from a device of the plurality of mobile communication devices an indication to change a zone designation of a geographic region at a current location of the device to a silent zone; retrieve any indications for the change of zone designation of the geographic region at the current location that were previously received from other devices of the plurality of mobile communication devices; and if a criterion for implementing the indicated change is met, record a change of the zone designation of the geographic region at the current location to a silent zone so as to cause a device of the plurality of mobile communication devices that is located within that geographic region to automatically switch its ring mode to silent mode.

Furthermore, in accordance with an embodiment of the present invention, the server is further configured to: receive from a device of the plurality of mobile communication devices an indication to change a zone designation of a geographic region at a current location of the device from a silent zone; and if a criterion for implementing the indicated change is met, change the zone designation of the geographic region at the current location from a silent zone so as to cause a device of the plurality of mobile communication devices that is located within that geographic region to automatically switch its ring mode to ringtone mode.

Furthermore, in accordance with an embodiment of the present invention, the geographic region is delimited as a region in which a signal from a wireless router is detectable or by geographic coordinates.

Furthermore, in accordance with an embodiment of the present invention, the current location is determined based on identification of a wireless router from which a signal is received by the device.

Furthermore, in accordance with an embodiment of the present invention, the identification of the wireless router includes identifying a wireless router of a plurality of wireless routers from which from which a strongest signal is received by the device.

Furthermore, in accordance with an embodiment of the present invention, the identification includes an Internet Protocol (IP) address.

Furthermore, in accordance with an embodiment of the present invention, the current location includes a location that is measured by a Global Positioning System (GPS) receiver of the device or by triangulation by a cellular telephone network.

Furthermore, in accordance with an embodiment of the present invention, the indication is generated in response to a manual change of a ring mode of the device to silent mode.

Furthermore, in accordance with an embodiment of the present invention, the criterion includes a minimum number of different devices of the plurality of mobile communication devices from which indications for the change of designation of the geographic region at the current location were previously received.

Furthermore, in accordance with an embodiment of the present invention, a database of geographic regions that are designated as silent zones is accessible by each device of the plurality of mobile communication devices.

Furthermore, in accordance with an embodiment of the present invention, the server is configured to send the database to the plurality of mobile communication devices.

Furthermore, in accordance with an embodiment of the present invention, each device of the plurality of mobile communication devices is associated with a unique identifier.

Furthermore, in accordance with an embodiment of the present invention, the server is configured to retrieve the previously received indications from a database of indications of changes of designation of geographic regions.

Furthermore, in accordance with an embodiment of the present invention, the server is configured to add the received indication to the database of indications when the criterion for implementing the indicated change is not met.

There is further provided, in accordance with an embodiment of the present invention, a method for location-based controlling of a ring mode of each device of a plurality of mobile communication devices, the method including: receiving from a device of the plurality of mobile communication devices an indication to change a zone designation of a geographic region at a current location of the device; retrieving any previously received indications for the change of the zone designation of the geographic region at the current location from other devices of the plurality of mobile communication devices; if a criterion for implementing the indicated change is met, changing the zone designation of the geographic region at the current location; and recording the change in zone designation in a database of silent zones that is accessible to each device of the plurality of mobile communication devices, each device configured such that if a device of the plurality of mobile communication devices is located within that geographic region that is designated as a silent zone, the ring mode of that device is automatically switched to silent mode, or if a device of the plurality of mobile communication devices is located within a geographic region that is not designated as a silent zone, the ring mode of that device is automatically switched to ringtone mode.

Furthermore, in accordance with an embodiment of the present invention, receiving the indication includes receiving an identifier of a wireless router from which a signal is received by the device or receiving geographic coordinates of the device.

Furthermore, in accordance with an embodiment of the present invention, the method includes sending the database of silent zones to the plurality of mobile communication devices.

There is further provided, in accordance with an embodiment of the present invention, a non-transitory computer readable storage medium having stored thereon instructions that when executed by a processor of a mobile communications device will cause the processor to: determine a current location of the device; access a database of geographic regions that are designated as silent zones to determine if the current location is within a silent zone; if the current location is within a silent zone, switching a ring mode of the device to silent mode, and if the current location is not within a silent zone, switching the ring mode to a ringtone mode; and transmit to a server an indication to change a zone designation of a geographic region at a current location of the device to or from a silent zone.

Furthermore, in accordance with an embodiment of the present invention, the current location includes an identifier of a wireless router from which a signal is received by the device or geographic coordinates of the device.

Furthermore, in accordance with an embodiment of the present invention, the instructions to transmit the indication include instructions to generate the indication in response to manually switching the ring mode of the device to silent mode or to ringtone mode.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is a schematic illustration of a system for location-based activation of mobile device silent mode, in accordance with an embodiment of the present invention.

FIG. 2 is a flowchart depicting a method for location-based activation of mobile device silent mode, in accordance with an embodiment of the present invention.

FIG. 3 is a flowchart depicting a method for determining silent zone designation of geographic region for location-based activation of mobile device silent mode, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a mobile communications device, such as a cellular telephone or other mobile communications device includes at least two ring modes, herein referred to as a silent mode and a ringtone mode. As used herein, a silent mode refers to a ring mode in which production of audible notifications is suspended. In a second ring mode, herein referred to as a ringtone mode, audible notifications are enabled. The mobile communications device is configured to automatically switch to silent mode when the device is located within predefined geographic regions, referred to herein as silent zones. As used herein, automatic switching of a ring mode from ringtone mode to silent mode, or automatically inhibiting (e.g., by requiring the user to respond to a warning message prior to manually switching to ringtone mode) switching from silent mode to ringtone mode, is referred to as automatic switching to silent mode. The automatic activation of the silent mode automatically stops, thus enabling audible notifications (unless the silent mode is otherwise, e.g., manually, activated), when the device is not located in or leaves a silent zone. Designation of geographic regions as silent zones may be modified in response to indications that are generated by mobile device users, e.g., bay manually switching a ring mode of the mobile devices to silent mode, or otherwise. A database of silent zones that is accessible by each mobile communications device may be maintained.

For example, an automatic silent mode activation application may be installed in a plurality of mobile communications devices. Each mobile communications device in which the automatic silent mode activation application is installed is herein referred to as a user device.

When in silent mode, a mobile communications device does not produce any audible notifications with a sound level that is greater than a threshold value (e.g., 50 dB, or another sound level). In some cases, the mobile communications device when in silent mode may produce another sensory notification, such as a palpable vibration. The ring mode in which the mobile communications device is configured to produce audible notifications above the threshold sound level is herein referred to as ringtone mode. An incoming communication that may cause a user device to produce an audible notification when in ringtone mode may include an incoming telephone call, short-message-service (SMS) text message, email, voice mail, or any other type of communication received by a cellular telephone handset.

A geographic location may be defined as a silent zone by operation of user devices at the location. For example, each user device may include a define function (e.g., operated by a screen button, a pushbutton, or otherwise). A user may operate the define function to indicate that the current location of the user device should be designated as a silent zone. For example, operation of the define function may include manually switching a user device to silent mode. Similarly, the define function may be operated to remove a silent zone designation from a geographic region, e.g., by manually switching to ringtone mode.

Whether or not a location is to be designated as a silent zone (and thereafter included in a database of silent zones) may be determined in accordance with predetermined criteria. For example, the criteria may be include designating a location as a silent zone when so indicated by a predetermined number (e.g., three, or another number) of different user devices. Similarly, the silent zone designation may be removed from a geographic location when such removal is indicated by operation of a predetermined number (e.g., three, or another number) of user devices.

The criteria may determine whether or not a location is to be designated as a silent zone in the event that contradictory zone designation change indications are received from different user devices. For example, the criteria may designate a geographic region as a silent zone in accordance with a simple majority of designation change indications by user devices. In some cases, the criteria may selectively weight different user devices (e.g., giving preferentially weighting an indication by a user device that is associated with a manager of geographic location, such as a proprietor or supervisor of a location), or may preferentially weight a current zone designation of the location.

A geographic region that is designated as a silent zone may be defined, delimited, or identified in one or more ways. For example, a user device at a geographic location may detect the presence of a wireless router (e.g., a router, e.g., a WiFi router, that enables wireless access to the Internet or other computer network based on IEEE 802.11 standards, whether accessible to the public or to a limited group of users). In this case, the silent zone may be defined to correspond to a hot spot in which a user device may receive the wireless signal from the wireless router (e.g., as identified by such wireless router's Internet protocol (IP) address). In other cases, the boundaries of the silent zone may be identified as a shape of predetermined size, or of user-indicated size, that surrounds a representative geographic coordinate of the user devices that were operated to designate the location as a silent zone. For example, the representative location may be an average of the positions from which the user devices were operated. Other representative positions may be used (e.g., weighted average, average with rejected outliers, or other representative position). A silent zone may be defined in terms of a predetermined shape (e.g., circle, oval, polygon, or other shape) that circumscribes the locations of the user devices from which indications were received. For example, the circumscribing shape may be surrounded by a margin of predetermined (e.g., selectable or otherwise) size. When a map or floor plan of a building is available, boundaries of the silent zone may be identified in accordance with known positions of walls of the building or room from which the user devices were operated. In some cases, the user device may be operated from several different points to indicate corners or sides of the silent zone.

Indication of silent zones by operation of user devices may be advantageous over other methods of indication of silent zones. For example, an individual user of a mobile communications device may have difficulty anticipating all potential locations where that user's mobile communications device should automatically activate the silent mode. It would similarly be difficult for a central agency to collect and register manually all points in a region or around the globe where mobile communications devices should automatically switch to silent mode.

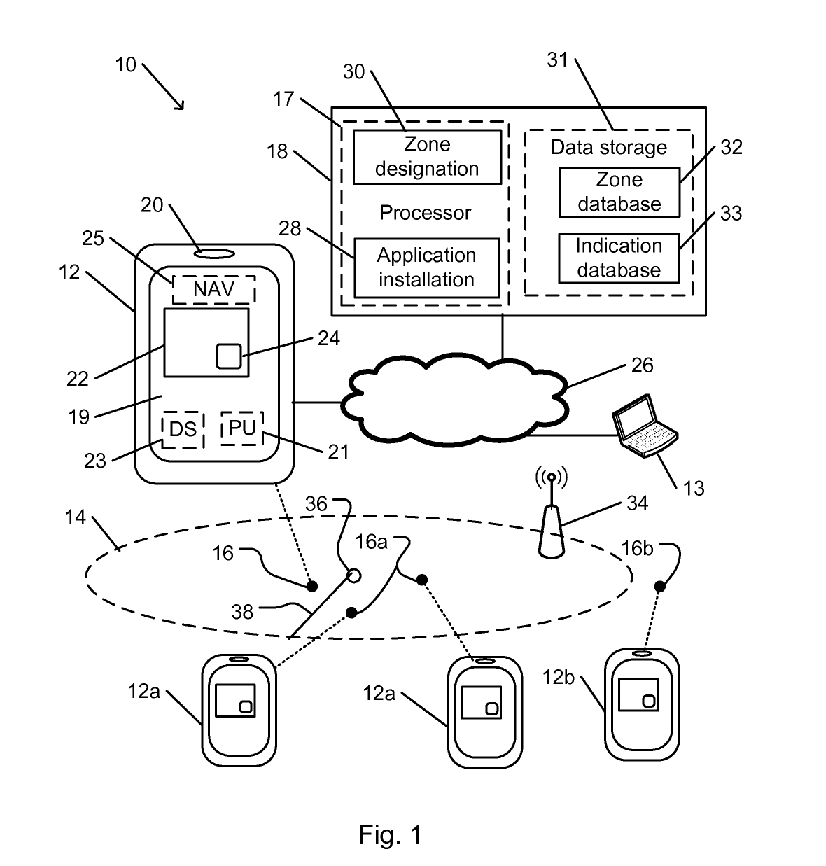

FIG. 1 is a schematic illustration of a system for location-based activation of mobile device silent mode, in accordance with an embodiment of the present invention.

Mobile device silent mode system 10 is configured to control one or more user devices 12 in accordance with a zone designation of a geographic region 14 that includes current location 16 of each user device. In particular, mobile device silent mode system 10 is configured to determine whether or not a current location 16 of a user device 12 is within or outside of a particular geographic region 14. Mobile device silent mode system 10 is additionally configured to determine whether or not a particular geographic region 14 is currently designated as a silent zone. Mobile device silent mode system 10 is additionally configured to change a zone designation of a geographic region 14 based on input from one or more user devices 12 or additional devices 13.

One or more user devices 12 may each include mobile communications device that includes a display screen 19 (e.g., in the form of a touch screen or other display screen) and a speaker 20. Speaker 20 may be operated by user device 12 to produce an audible notification or other sounds (e.g., received or stored audio content). User device 12 may be operated in a silent mode in which sound production by speaker 20 is limited (e.g., to certain types of produced sound, or below a predetermined sound intensity level).

Each user device 12 has a processing unit (PU) 21 that is configured to operate in accordance with programmed instructions that are stored in data storage (DS) unit 23. For example, data storage unit 23 may represent one or more volatile or nonvolatile fixed or removable data storage devices. Some or all of the data storage devices of data storage unit 23 may be incorporated locally into user device 12, or may be located outside of user device 12 but in communication with processing unit 21. Data storage unit 23 may be utilized to store parameters used in operation of processing unit 21, or results of operation of processing unit 21.

In particular, processing unit 21 may be configured to execute an automatic silent mode activation application. For example, the application may be installed on each user device 12, as represented schematically by silent mode application 22 (e.g., accessible to a user of user device 12 via an icon that is displayed on display screen 19 of user device 12). Execution of silent mode application 22 may enable operation or zone indication module 24 (e.g., by enabling operation of one or more screen controls, pushbuttons, or other user operable controls) that may be operated by a user of user device 12. For example, operation of zone indication module 24 may be initiated by operation of a screen control or pushbutton to manually toggle user device 12 between silent mode and ringtone mode. Zone indication module 24 may operate to indicate designation of a geographic region 14 as a silent zone, or to indicate removal of silent zone designation from a geographic region 14. The generated indication may be transmitted via network 26 to server 18 (e.g., zone definition module 30 on server 18).

Each user device 12 includes a navigation (NAV) unit 25. Navigation unit 25 includes one or more devices that enable determination of a geographic location of user device 12. For example, navigation unit 25 may include a receiver of signals that are produced by the Global Positioning System (GPS) or by another navigation satellite system. In some cases, GPS data may be supplemented by data from other navigation-related sensors (e.g., a compass, gyroscope, tilt sensor, accelerometer, or another sensor). In some cases, communication signals that are produced by user device 12 and that are received by various cells of a cellular telephone network may be analyzed (e.g., by triangulation or otherwise) to yield an approximate position of user device 12.

In some cases, a wireless router 34 (e.g., a WiFi transceiver or another type of wireless router or communication point) may be located within geographic region 14. In such a case, user device 12 may be considered to be located within that geographic region 14 when user device is near enough to wireless router 34 to enable intercommunication between user device 12 and wireless router 34.

Each user device 12 is configured to communicate with one or more other devices via network 26. The devices with which user device 12 may communicate may include other user devices 12, server 18, or other devices. Network 26 may include one or more of a mobile telephone (e.g., cellular) network, the Internet, a telephone network, a local wired or wireless network, or a wired or wireless connection to a network, direct wired or wireless connections between devices, or another network or network component.

In some cases, one or more additional devices 13 (e.g., fixed or portable computers or computer terminals) may communicate with one or more user devices 12 or with server 18 via network 26. For example, an additional device 13 may be associated with a supervisor of mobile device silent mode system 10, of a particular geographic region 14, or with another person or user.

Server 18 may represent a single device (e.g., computer) or a cluster of interconnected devices (e.g., one or more computers or peripheral devices) at a single location, or may represent a plurality of intercommunicating devices that are located remotely from one another. For example, in some cases, some or all of the described functionality of server 18 may be distributed among one or more user devices 12 or additional devices 13.

Server 18 includes processor 17 that is configured to operate in accordance with programmed instructions. Processor 17 may include one or more processing units, e.g., of one or more computers.

For example, one or more of programmed instructions for operation of processor 17, parameters and data for use or processing during operation of processor 17, and results of operation of processor 17, may be stored on data storage device 31. Data storage device may include one or more volatile or nonvolatile, fixed or removable, local or remote data storage devices.

For example, processor 17 may be configured to execute application installation module 28. Application installation module 28 may be configured to install silent mode application 22 on a user device 12. For example, a user of a mobile communications device may operate the device to contact server 18 (e.g., by operating a network browser to contact a website that is associated with server 18. Establishment of the contact may initiate execution of application installation module 28. After collecting information from the mobile device (e.g., identifying information, billing information, or other information), execution of application installation module 28 may cause server 18 to send an installation file to the mobile device network 26. Execution of application installation module 28 may assign each user device 12 a unique identifier (e.g., a number or code). Processing unit 21 of mobile device may execute the installation file to store programmed instructions for silent mode application 22 on data storage unit 23, thus converting the mobile device into a user device 12.

Processor 17 may be configured to execute zone designation module 30. Execution of zone designation module 30 may determine whether or not one or more geographic regions 14 are to be designated as silent zones. For example, a user of a user device 12 may operate a user control to manually switch user device 12 to silent mode or to ringtone mode. The resulting execution of zone indication module 24 of silent mode application 22 may transmit to server 18 via network 26 an indication of the switching of the mode.

The indication that is transmitted from user device 12 to server 18 may include information indicative of a current location 16 of user device 12. For example, the location information may include geographic coordinates (e.g., GPS coordinates or other geographic location coordinates) of user device 12 as determined by navigation unit 25. The location information may include an identifier, such as an Internet Protocol (IP) address of a wireless router 34 from which a signal is received by user device 12. In the event that signals are received from more than one wireless router 34, execution of silent mode application 22 may select the identifier of the wireless router 34 that produces the strongest received signal to be transmitted to server 18.

Execution of zone designation module 30 may apply criteria to determine whether or not a zone designation of a geographic region 14 is to be changed. For example, the criteria may be based on a count of the number of different user devices 12 that are operated to indicate a change in zone designation of a geographic region 14. If the number of different user devices 12 indicating a change exceeds a threshold number (e.g., three, or another number), then the zone designation of that geographic region 14 may be changed. In the event that contradictory indications are transmitted by different user devices 12, the zone designation may be determined by a majority (e.g., if the number of indications in the majority is greater than the threshold number, if a difference between the majority and the minority is greater than the threshold number, or otherwise). Alternatively or in addition, other criteria may be applied. For example, indications transmitted by some user devices 12 may be weighted more than others.

For example, a current location 16 of user device 12 may be within geographic region 14. The current locations 16a of one or more additional user devices 12a may also be located within geographic region 14. If a sufficient number of indications of change of designation are transmitted to server 18 by user devices 12 and 12a, the designation of geographic region 14 may be changed.

Execution of zone designation module 30 may determine geographic boundaries of, or otherwise delimit, a geographic region 14 that is designated to be a silent zone. For example, if a current location 16 of user device 12 is specified by an identifier of a wireless router 34, geographic region 14 may be specified to coincide with a region (hot spot) within an signal from wireless router 34 (e.g., with an intensity above a threshold value) is received.

If current locations 16 and 16a of user devices 12 and 12a are specified by geographic coordinates, a representative location 36 may be identified. For example, representative location 36 may be calculated by calculating a simple average location of current locations 16 and 16a, or may be calculated otherwise (e.g., as a “center of weight” of differently weighted current locations 16 and 16a, by excluding outlying current locations 16 and 16a from the calculation, by a nonlinear calculation, or otherwise). A region having a predetermined representative dimension 38 (e.g., a radius of a circular geographic region 14, such as 30 meters to 50 meters or another radius, a dimension of a square or polygonal region, or other representative dimension) surrounding representative location 36 may be defined. In some cases, execution of zone designation module 30 may cause server 18 to send an indication to one or more user devices 12 and 12a to indicate a size of geographic region 14. For example, the size may be entered manually (e.g., by entering a dimension value or by indicating on a map), or may be entered by carrying user device 12 or 12a to sides or corners of geographic region 14. When a plan of a building or room is available, geographic region 14 may be defined to correspond to the building or room.

Identified geographic regions 14 and the current zone designation of each may be stored in zone database 32, e.g., on data storage device 31 of server 18. In some cases, content of zone database 32 may be limited to geographic regions 14 that were designated as silent zones. In some cases, each silent zone may be associated with a unique identifier or index. The identifier may be designed in a manner that is indicative of the location of the silent zone or that facilitates retrieval from the database of silent zones that are close to a current location 16 of a user device 12.

Indication database 33 may include current locations 16 for which a change of zone designation is pending, together with the identifiers of user devices 12 from which indications for the change were received. For example, indications for change of zone designation may have been received from an insufficient number of user devices 12 at current locations 16 in order to implement the change in designation. The change in zone designation may be implemented upon subsequent receipt of a sufficient number of indications.

In some cases, indication database 33 and zone database 32 may be incorporated into a single database (e.g., with a single indexing system).

Each silent zone may in zone database 32 may be associated with sufficient information in order to classify any current location 16 of any user device 12 as either within or outside of each silent zone. For example, the silent zone may be associated with an identification of a wireless router 34 with which user device 12 may communicate when within the hot spot of that wireless router 34. The silent zone may be associated with a geographic coordinate (e.g., a GPS coordinate) and a size (which may be standard or arbitrary, e.g., based on a representative size of a typical silent zone) of a radius surrounding that geographic coordinate. The silent zone may be associated with a plurality of geographic coordinates, boundary points or lines that delimit the silent zone.

In some cases, a silent zone may be accompanied by an indication of a time period or expiration time for the silent zone designation of a geographic region 14. Execution of silent mode application 22 on a user device 12 enables access by user device 12 to zone database 32.

When a user device 12 or 12a is moved to a current location 16 or 16a within a geographic region 14 that is designated as a silent zone, execution of silent mode application 22 switches each user device 12 or 12a to silent mode. When a user device 12b is moved to a current location 16b that is outside of a geographic region 14 that is designated as a silent zone, or when the silent zone designation of geographic region 14 is canceled, execution of silent mode application 22 switches user device 12b to ringtone mode.

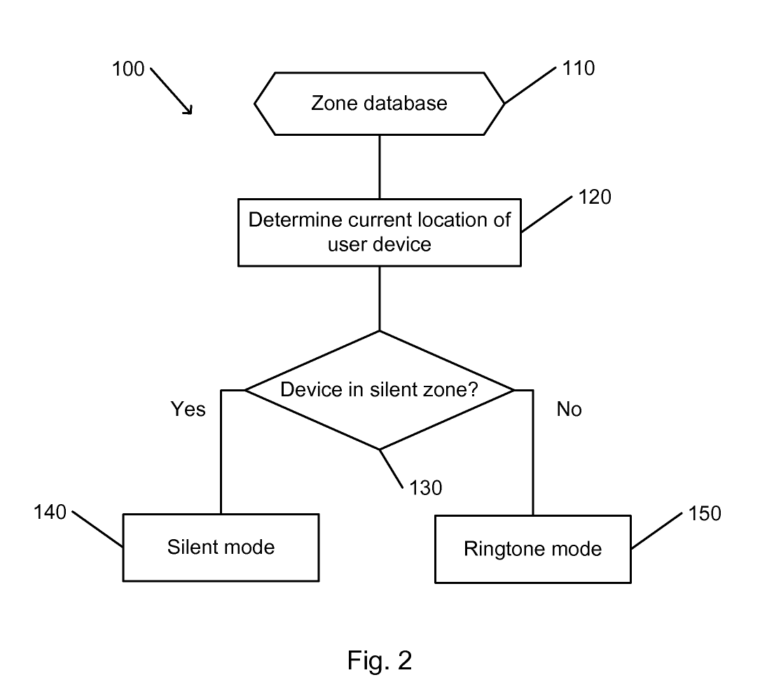

FIG. 2 is a flowchart depicting a method for location-based activation of mobile device silent mode, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

User device silent mode method 100 may be executed by a processing unit 21 of a user device 12. User device silent mode method 100 may be executed in a continuous loop, at predetermined intervals (e.g., equivalent to a typical time interval required for walking from outside a silent zone into a silent zone or vice versa, or another predetermined time interval), or when triggered by a predetermined event. For example, a predetermined event may include motion through a predetermined distance (e.g., a distance that is typical of a size of a silent zone), detected change in speed of motion (e.g., indicative of staying at a location), or another predetermined event.

Prior to or during execution of user device silent mode method 100, access to zone database 32 is enabled (block 110). For example, access by user device 12 to zone to zone database 32 may be enabled via network 26. All or part of zone database 32 may be downloaded to user device 12, e.g., to data storage unit 23 of user device 12. For example, zone database 32 may be downloaded to user device 12 at predetermined intervals, or in response to an update of zone database 32 (e.g., addition or removal of a silent zone). In some cases, only part of zone database 32 may be downloaded to user device 32. For example, only a portion of zone database 32 that relates to general geographic area (e.g., neighborhood, city, country or other) that includes current location 16 of user device 12 may be downloaded to that user device 12.

Current location 16 of user device 12 may be determined (block 120). For example, wireless routers 34 with which user device 12 is currently in communication may be identified. As another example, a GPS sensor of navigation unit 25 of user device 12 may be operated to determine geographic coordinates of current location 16.

The determined current location 16 may be compared with the locations of the silent zones that are included in zone database 32 (block 130). For example, identified wireless routers 34 may be compared against wireless routers 34 that are associated with silent zones in zone database 32. Coordinates of current location 16 may be compared with coordinates of silent zones in zone database 32.

It may be determined that current location 16 is within a silent zone. For example, user device 12 may be in communication with a wireless router 34 that is in associated with a silent zone in zone database 32. Geographic coordinates of current location 16 may be within a geographic region 14 that is associated with a silent zone in zone database 32. A user device 12 that was previously determined to be outside of all silent zones may be determined at later time to be within a silent zone due to movement into a previously existing silent zone, or due to re-designation of a geographic region 14 to a silent zone.

In this case, user device 12 may be placed in silent mode (block 140). For example, a user device 12 that is in ringtone mode may be switched to silent mode. A notification may be generated, e.g., displayed on display screen 19 of user device 12, to notify a user of user device 12 of the switch to silent mode. A user device 12 that is switched to silent mode (including a user device 12 that was in silent mode prior to execution of user device silent mode method 100) may be inhibited from being switched to ringtone mode. For example, when operating user device 12 to manually switch to ringtone mode, a warning may be displayed, and the user may be required to verify the switch to ringtone mode. After user device 12 is switched to silent mode, execution of user device silent mode method 100 may continue (e.g., periodically) to determine whether or not silent mode is to continue.

It may be determined that current location 16 is not within a silent zone. For example, user device 12 may be not be in communication with any wireless router 34 that is in associated with a silent zone in zone database 32. Geographic coordinates of current location 16 may be outside of all geographic regions 14 that are associated with silent zones in zone database 32. A user device 12 that was previously determined to be within a silent zone may be determined at later time to be outside of all silent zones due to movement out of the silent zone, or due to cancellation of a designation of a geographic region 14 as a silent zone.

In this case, user device 12 may be placed in ringtone mode (block 150). For example, a user device 12 that is in silent mode may be switched to ringtone mode. A notification may be generated, e.g., displayed on display screen 19 of user device 12, to notify a user of user device 12 of the switch to ringtone mode. A user device 12 that is already in ringtone mode may remain in ringtone mode. During this time, a user may operate user device 12 to manually switch to silent mode. When user device 12 is in ringtone mode, execution of user device silent mode method 100 may continue (e.g., periodically) to determine whether or not ringtone mode is to continue.

User devices 12 and 12a may be operated to change a zone designation of a geographic region 14 from or to a silent zone.

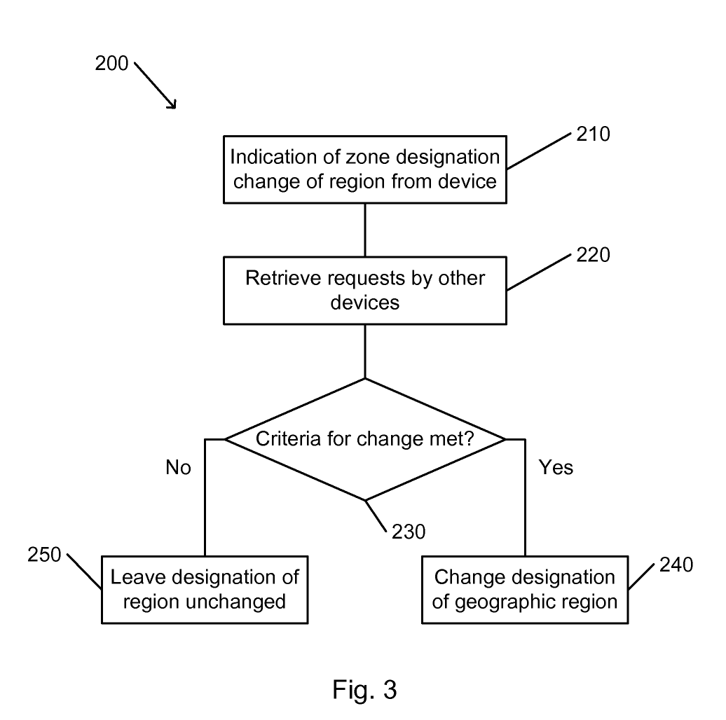

FIG. 3 is a flowchart depicting a method for determining silent zone designation of a geographic region for location-based activation of mobile device silent mode, in accordance with an embodiment of the present invention.

Silent zone designation method 200 may be executed by a processor 17 of a server 18 of mobile device silent mode system 10. Silent zone designation method 200 may be executed continuously by server 18, may be executed at predetermined intervals (e.g., typical of a time period between successive received indications from devices of mobile device silent mode system 10), or may be executed in response to a predetermined event. For example, a predetermined event may include receiving a signal, message or other indication to change a zone designation of a geographic region 14 to or from a silent zone.

An indication of change of zone designation may be received (via network 26) from a device of mobile device silent mode system 10, such as a user device 12 or an additional device 13 (block 210). For example, the indication may be generated by manual switching of user device 12 from ringtone mode to silent mode, or vice versa. Alternatively or in addition, a user may otherwise indicate a change of designation. An operator of an additional device 13 (e.g., a supervisor of a room such as a meeting or conference room, auditorium, office, classroom, hall, theater, house of prayer, or other geographic location 14, or another person) may operate additional device 13 to indicate a change of designation of a particular geographic region 14.

The indication may include a location of a region regarding which the change in designation is indicated. When the indication is received from a user device 12, a location of that user device 12 may be determined For example, the location may be defined as a hot spot of a wireless router 34 with which that user device 12 is in communication (e.g., from which the strongest signals are being received). The wireless router 34 may be identified by its IP address, or otherwise. As another example, geographic coordinates of current location 16 of user device 12 may be measured, e.g., by operation of navigation unit 25 of user device 12. In some cases, a location of geographic region 14 may be manually entered (e.g., selected from a displayed map or building plan, or otherwise). An operator of additional device 13 may select a location of geographic region 14, e.g., from a list of geographic regions 14 with which that additional device 13 is associated.

Indications to change the zone designation of geographic region 14 may be retrieved from indication database 33 (block 220). For example, indication database 33 may be searched to determine if indications were received from other user devices 12 and 12a with current locations 16a within a common geographic region 14. The identity of each other indicating user device 12 may be determined by comparison of the identifiers of each indicating user device. For example, a common geographic region 14 may include a hot spot of a single wireless router 34. A the current locations 16 and 16a may be considered to be located within a common geographic region 14 when a maximum mutual distance between current locations 16 and 16a is less than a maximum predetermined distance. A the current locations 16 and 16a may be considered to be located within a common geographic region 14 when all are located within a common structure (e.g., room, building, enclosure, or other predefined structure) or other predefined region as determined by a representation of a map or floor plan (where available).

Criteria may be applied to determine if the indication for change of zone designation is to be implemented (block 230). For example, the criteria may include a minimum number of different user devices 12 and 12a from which indications for the change have been received.

In some cases, an indication by a supervisor of geographic region 14 (e.g., operating a user device 12 or an additional device 13) may be weighted more heavily (e.g., may be counted as more than a single user device 12). For example, a supervisor of geographic region 14 may indicated a change in designation of that geographic region 14 in light of a scheduled event at that geographic region 14.

In some cases, a predetermined time limit may be imposed on an indication of change in zone designation. For example, the time limit may be determined in accordance with a typical duration of an event for which a geographic region 14 is to be designated as a silent zone. Thus, if an indication is received after a previous indication has expired, then that indication is interpreted as a first indication. For example, an expired indication may be deleted from indication database 33. In some cases, no time limit is imposed. Thus, an indication for change of zone designation may be implemented when unlimited time has elapsed between subsequent received indications for the change in zone designation.

When contradictory indications are received from a single user device 12, the later indication may replace the earlier indication (or may result in removal of the first indication from indication database 33 when the later indication is to return to the current zone designation of geographic region 14).

Criteria may be provided for determining whether to implement a change in zone designation of a geographic region 14 when contradictory indications are received from different user devices 12 and 12a. For example, users of some user devices 12 in a geographic region 14 may manually switch to silent mode, while others may manually switch to ringtone mode. Such criteria may take into account, for example, the number of each type of indication (e.g., a majority vote), the interval between subsequent received indications (e.g., a large number of received indications of one type within a short period of time may be indicative of the start of an event that requires silent mode), or other factors.

When the analysis indicates that a change of zone designation is to be implemented, the zone designation of geographic region 14 may be changed (block 140). For example, a geographic region 14 (that was not previously included in zone database 32 as a silent zone) may be added to zone database 32 as a new silent zone. An entry that is made into zone database 32 may include a unique identifier or index of geographic region 14, and an indication of a location of geographic region 14. For example, geographic region 14 may defined as coinciding with a hot spot of an identified (e.g., by IP address or otherwise) wireless router 34. A location of geographic region 14 may be identified by a representative location 36 (geographic coordinate) of current locations 16 and 16a. Boundaries of geographic region 14 may be identified by a predetermined representative dimension 38 of geographic region 14. For example, representative dimension 38 may represent a radius (as shown in FIG. 1), a dimension of a polygon (e.g., side, apothem, circumradius, or other), or another representative dimension. In some cases, an identified location of a geographic region 14 may be based on a shape (e.g., circle, oval, polygon, or other shape) that circumscribes current locations 16 and 16a of all user devices 12 and 12a that indicated the change in zone designation. For example, the boundaries of geographic region 14 may be identified by the circumscribed shape, surrounded by a margin of predetermined width.

As another example, a geographic region 14 that was previously designated as a silent zone in zone database 32 may be removed from zone database 32, or otherwise indicated as no longer being designated as a silent zone.

When a change is made to zone database 32, the relevant change of zone designation indications may be deleted from indication database 33.

When the analysis indicates that the indicated change of zone designation is not to be implemented, the zone designation of geographic region 14 remains unchanged (block 150). The indication for change of zone designation may be stored in indication database 33, e.g., to await further indications of change of zone designation from other user devices 12a.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for location-based control of a ring mode of each device of a plurality of mobile communication devices, the system comprising:
a server configured to communicate with said plurality of mobile communication devices via a network and configured to:
receive from a device of said plurality of mobile communication devices an indication to change a zone designation of a geographic region at a current location of the device to a silent zone;
retrieve any indications for the change of zone designation of the geographic region at the current location that were previously received from other devices of said plurality of mobile communication devices; and
if a criterion for implementing the indicated change is met, record a change of the zone designation of the geographic region at the current location to a silent zone so as to cause a device of said plurality of mobile communication devices that is located within that geographic region to automatically switch its ring mode to silent mode.

2. The system of claim 1, wherein the server is further configured to:
receive from a device of said plurality of mobile communication devices an indication to change a zone designation of a geographic region at a current location of the device from a silent zone; and
if a criterion for implementing the indicated change is met, change the zone designation of the geographic region at the current location from a silent zone so as to cause a device of said plurality of mobile communication devices that is located within that geographic region to automatically switch its ring mode to ringtone mode.

3. The system of claim 1, wherein the geographic region is delimited as a region in which a signal from a wireless router is detectable or by geographic coordinates.

4. The system of claim 1, wherein the current location is determined based on identification of a wireless router from which a signal is received by the device.

5. The system of claim 4, wherein the identification of the wireless router comprises identifying a wireless router of a plurality of wireless routers from which from which a strongest signal is received by the device.

6. The system of claim 4, wherein the identification comprises an Internet Protocol (IP) address.

7. The system of claim 1, wherein the current location comprises a location that is measured by a Global Positioning System (GPS) receiver of the device or by triangulation by a cellular telephone network.

8. The system of claim 1, wherein the indication is generated in response to a manual change of a ring mode of the device to silent mode.

9. The system of claim 1, wherein the criterion comprises a minimum number of different devices of said plurality of mobile communication devices from which indications for the change of designation of the geographic region at the current location were previously received.

10. The system of claim 1, wherein a database of geographic regions that are designated as silent zones is accessible by each device of said plurality of mobile communication devices.

11. The system of claim 10, wherein the server is configured to send the database to said plurality of mobile communication devices.

12. The system of claim 1, wherein each device of said plurality of mobile communication devices is associated with a unique identifier.

13. The system of claim 1, wherein the server is configured to retrieve the previously received indications from a database of indications of changes of designation of geographic regions.

14. The system of claim 13, wherein the server is configured to add the received indication to the database of indications when the criterion for implementing the indicated change is not met.

15. A method for location-based controlling of a ring mode of each device of a plurality of mobile communication devices, the method comprising:
receiving from a device of said plurality of mobile communication devices an indication to change a zone designation of a geographic region at a current location of the device;
retrieving any previously received indications for the change of the zone designation of the geographic region at the current location from other devices of said plurality of mobile communication devices;
if a criterion for implementing the indicated change is met, changing the zone designation of the geographic region at the current location; and
recording the change in zone designation in a database of silent zones that is accessible to each device of said plurality of mobile communication devices, each device configured such that if a device of said plurality of mobile communication devices is located within that geographic region that is designated as a silent zone, the ring mode of that device is automatically switched to silent mode, or if a device of said plurality of mobile communication devices is located within a geographic region that is not designated as a silent zone, the ring mode of that device is automatically switched to ringtone mode.

16. The method of claim 15, wherein receiving the indication comprises receiving an identifier of a wireless router from which a signal is received by the device or receiving geographic coordinates of the device.

17. The method of claim 15, comprising sending the database of silent zones to said plurality of mobile communication devices.

18. A non-transitory computer readable storage medium having stored thereon instructions that when executed by a processor of a mobile communications device will cause the processor to:
determine a current location of the device;
access a database of geographic regions that are designated as silent zones to determine if the current location is within a silent zone;
if the current location is within a silent zone, switching a ring mode of the device to silent mode, and if the current location is not within a silent zone, switching the ring mode to a ringtone mode; and
transmit to a server an indication to change a zone designation of a geographic region at a current location of the device to or from a silent zone.

19. The non-transitory computer readable storage medium of claim 18, wherein the current location comprises an identifier of a wireless router from which a signal is received by the device or geographic coordinates of the device.

20. The non-transitory computer readable storage medium of claim 18, wherein the instructions to transmit the indication include instructions to generate the indication in response to manually switching the ring mode of the device to silent mode or to ringtone mode.
